(19) United States
(12) Patent Application Publication
(10) Pub. No.: US 2008/0074235 A1
(43) Pub. Date: Mar. 27, 2008

(54) ELECTRONIC KEY ACCESS CONTROL SYSTEM AND METHOD

(75) Inventors: Albert Wong, Plymouth, MN (US); Scott William Gardeen, Bloomington, MN (US); Donald R. Genadek, St. Louis Park, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Datakey Electronics, Inc.

(21) Appl. No.: 11/763,127

(22) Filed: Jun. 14, 2007

Related U.S. Application Data
(63) Continuation of application No. 10/893,648, filed on Jul. 16, 2004, now abandoned.
(60) Provisional application No. 60/488,072, filed on Jul. 17, 2003.

(51) Int. Cl. G06F 7/04

(52) U.S. Cl. 340/5.22; 235/382.5

(57) ABSTRACT

An electronic key access control system is provided with enhanced access control capabilities. In one embodiment, an electronic key access control system includes an electronic key or token key-like device, and a self-contained, scaleable stand-alone electronic lock controller that is operable in a plurality of access modes to allow access depending on a level of access allowance granted to the electronic key. The system can be used to replace low security mechanically programmed locksets or as a security add-on to standard keyed locksets.

### CROSS-REFERENCE TO RELATED APPLICATION

This application claims priority of U.S. provisional patent application No. 60/488,072 filed Jul. 17, 2003; the subject matter of which is incorporated herein by reference.

### FIELD OF THE INVENTION

The present invention relates generally to an electronic key access control system and method, and more particularly, to an electronic key access control system and method having an electronic key and lock controller with enhanced access control capabilities.

### BACKGROUND OF THE INVENTION

Traditional key locks or programmable mechanical lock sets have been used in many applications, such as security of a facility. In these and other applications, access control systems and methods have been implemented to grant access only to authorized users for, particularly, security purposes. However, the traditional access control systems and methods are very costly. Also, traditional key locks or programmable mechanical lock sets have caused a number of administrative headaches, such as restricting access, duplicating mechanical keys, changing locks, and distributing updated access codes or keys to all of the users, etc. Therefore, there is a need for an improved access control system and method.

In addition, electronic key systems have been used over the years and have proven to be a reliable mechanism for access control solutions. Exemplary electronic key systems include an electrical/electronic key-like device and an electrical key receptacle as disclosed in U.S. Pat. No. 4,752,679, entitled “RECEPTACLE DEVICE”, issued on Jun. 21, 1988; U.S. Pat. No. 4,659,915, entitled “RECEPTACLE DESIGN FOR USE WITH ELECTRONIC KEY-LIKE DEVICE”, issued on Apr. 21, 1987; U.S. Pat. No. 4,522,456, entitled “ELECTRONIC TAG RECEPTACLE AND READER”, issued on Jun. 11, 1985; U.S. Pat. No. 4,620,088, entitled “RECEPTACLE DESIGN FOR USE WITH ELECTRONIC KEY-LIKE DEVICE”, issued on Oct. 28, 1986; U.S. Design Pat. No. Des. 345,686, entitled “ELECTRICAL INFORMATION KEY”, issued on Apr. 5, 1994; U.S. Pat. No. 4,578,573, entitled “PORTABLE ELECTRONIC INFORMATION DEVICES AND METHOD OF MANUFACTURE”, issued on Mar. 25, 1986; U.S. Pat. No. 4,549,076, entitled “ORIENTATION GUIDE ARRANGEMENT FOR ELECTRONIC KEY AND RECEPTACLE COMBINATION”, issued on Oct. 22, 1985; U.S. Pat. No. 4,436,993, entitled “ELECTRONIC KEY”, issued on Mar. 13, 1984; U.S. Pat. No. 5,073,703, entitled “APPARATUS FOR ENCODING ELECTRICAL IDENTIFICATION DEVICES BY MEANS OF SELECTIVELY FUSIBLE LINKS”, issued on Dec. 17, 1991; U.S. Design Pat. No. Des. 291,897, entitled “IDENTIFICATION TAG”, issued on Sep. 15, 1987; U.S. Pat. No. 4,326,125, entitled “MICROELECTRONIC MEMORY KEY WITH RECEPTACLE AND SYSTEMS THEREFOR”, issued on Apr. 20, 1982; and U.S. Pat. No. 4,297,569, entitled “MICROELECTRONIC MEMORY KEY WITH RECEPTACLE AND SYSTEMS THEREFOR”, issued on Oct. 27, 1981; all of which are assigned to Datakey Electronics, Inc., the assignee of the present application, and all of which are incorporated herein by reference.

Therefore, there is a need for an improved electronic key access control system and method.

### SUMMARY OF THE INVENTION

The present invention provides an improved electronic key access control system having an electronic key and a lock controller with enhanced access control capabilities. In one embodiment of the present invention, an electronic key access control system includes an electronic key or token key-like device, and a self-contained, scaleable stand-alone electronic lock controller that is operable in a plurality of access modes to allow access depending on a level of access allowance granted to the electronic key. The present invention can be used to replace low security mechanically programmed locksets or as a security add-on to standard keyed locksets.

In one embodiment, the controller includes a memory for storing data related to a plurality of electronic keys and respective levels of access allowance and operation events of the electronic keys. The controller is also capable of being updated by data transferred from an electronic key and capable of downloading data to an electronic key.

In one embodiment, the controller is configured and arranged to operate with a lock activation and deactivation device to grant or restrict access by the electronic key.

In one embodiment, when a lost/stolen key is harvested, i.e. restricting or denying access by the lost/stolen key, the controller is updated without having to re-key or replace the lock activation and deactivation device.

In one embodiment of the present invention, the electronic key can be configured and arranged to many different key types, such as a user access key, an administrative key, and a data transfer key, etc.

In one embodiment, the electronic key is a serialized key for protecting against key copying and includes a memory for storing data such as a key type, a unique serial number, and access allowance specific to the electronic key. The serial number cannot be duplicated so as to insure that the data residing on the key cannot be copied for malicious purposes.

In one embodiment, the electronic key access control system may include application software that is used to program keys for lock controllers as well as present audit data from user transactions. The software has a friendly user interface for ease of use. In one embodiment, a left to right arrangement of buttons and tabbed folders give a user a hierarchical flow for entering pertinent information.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 illustrates a perspective view of one embodiment of an electronic key access control system having an electronic key and a key receptacle in accordance with the principles of the present invention.

FIG. 2 illustrates a block diagram of one embodiment of an electronic key access control system in accordance with the principles of the present invention.

FIG. 3 illustrates a perspective view of a second embodiment of a key receptacle of an electronic key access control system in accordance with the principles of the present invention.

FIG. 4 illustrates another perspective view of the key receptacle shown in FIG. 3 in accordance with the principles of the present invention.

FIG. 5 illustrates a perspective view of a third embodiment of a key receptacle of an electronic key access control system in accordance with the principles of the present invention.

### DETAILED DESCRIPTION OF THE PREFERRED EMBODIMENTS

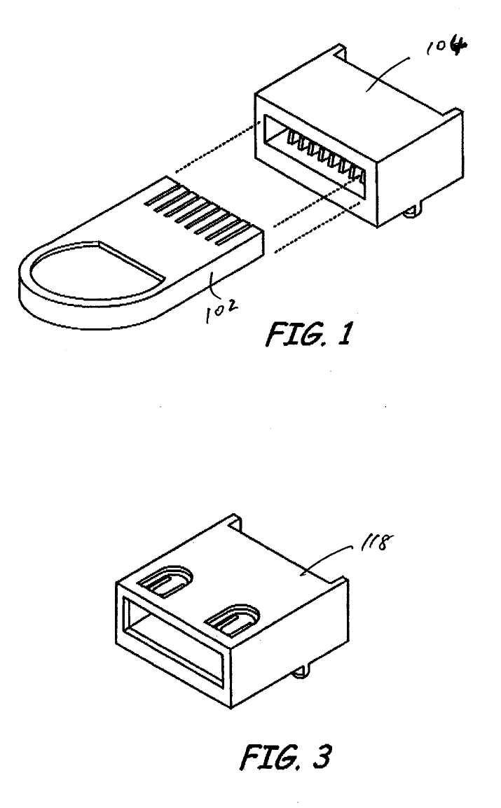

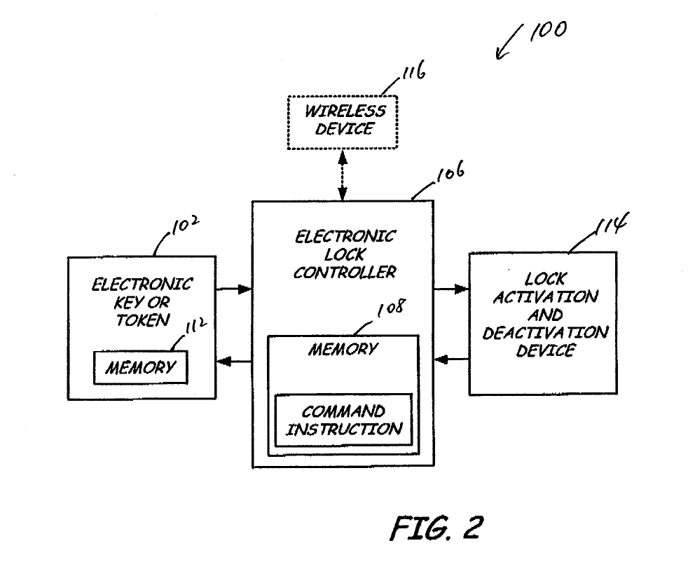

The present invention provides an electronic key access control system having an electronic key and a lock controller with enhanced access control capabilities. FIG. 1 illustrates one embodiment of an electronic key access control system 100 which includes an electronic key (or a token key-like device) 102, and a key receptacle 104, an electronic lock controller 106 (in FIG. 2) coupled to, e.g. electrically connected to or connected to via a wireless protocol, the key receptacle 104. The lock controller 106 is operable in a plurality of access modes to allow access depending on a level of access allowance granted to the electronic key 102.

It is appreciated that the key 102 can be configured and arranged to have many different key shapes, such as a flat shape or a regular key-like shape, and many different key types, such as a user access key, an administrative key, and a data transfer key, etc. It is also appreciated that the key receptacle 104 can be configured and arranged to have many key receptacle shapes to receive and be operable with the key 102, for example, a flat token receptacle for receiving a flat token as shown in FIG. 1, or a regular key receptacle for receiving a regular key-shaped device. Other exemplary electronic keys and key receptacles have been described in U.S. Pat. No. 4,752,679, entitled “RECEPTACLE DEVICE”, issued on Jun. 21, 1988; U.S. Pat. No. 4,659,915, entitled “RECEPTACLE DESIGN FOR USE WITH ELECTRONIC KEY-LIKE DEVICE”, issued on Apr. 21, 1987; U.S. Pat. No. 4,522,456, entitled “ELECTRONIC TAG RECEPTACLE AND READER”, issued on Jun. 11, 1985; U.S. Pat. No. 4,620,088, entitled “RECEPTACLE DESIGN FOR USE WITH ELECTRONIC KEY-LIKE DEVICE”, issued on Oct. 28, 1986; U.S. Design Pat. No. Des. 345,686, entitled “ELECTRICAL INFORMATION KEY”, issued on Apr. 5, 1994; U.S. Pat. No. 4,578,573, entitled “PORTABLE ELECTRONIC INFORMATION DEVICES AND METHOD OF MANUFACTURE”, issued on Mar. 25, 1986; U.S. Pat. No. 4,549,076, entitled “ORIENTATION GUIDE ARRANGEMENT FOR ELECTRONIC KEY AND RECEPTACLE COMBINATION”, issued on Oct. 22, 1985; U.S. Pat. No. 4,436,993, entitled “ELECTRONIC KEY”, issued on Mar. 13, 1984; U.S. Pat. No. 5,073,703, entitled “APPARATUS FOR ENCODING ELECTRICAL IDENTIFICATION DEVICES BY MEANS OF SELECTIVELY FUSIBLE LINKS”, issued on Dec. 17, 1991; U.S. Design Pat. No. Des. 291,897, entitled “IDENTIFICATION TAG”, issued on Sep. 15, 1987; U.S. Pat. No. 4,326,125, entitled “MICROELECTRONIC MEMORY KEY WITH RECEPTACLE AND SYSTEMS THEREFOR”, issued on Apr. 20, 1982; and U.S. Pat. No. 4,297,569, entitled “MICROELECTRONIC MEMORY KEY WITH RECEPTACLE AND SYSTEMS THEREFOR”, issued on Oct. 27, 1981; all of which are assigned to Datakey Electronics, Inc., the assignee of the present application, and all of which are incorporated herein by reference.

FIG. 2 illustrates a block diagram of one embodiment of the electronic key access control system 100 in accordance with the principles of the present invention. The lock controller 106 includes a memory 108 for storing data related to a plurality of electronic keys 102 and respective levels of access allowance and operation events of the electronic keys 102. The lock controller 106 is also capable of being updated by data transferred from the electronic key 102 and capable of downloading data to the electronic key 102. The key 102 includes a memory 112 to store data transferred to and from the lock controller 106 or other suitable data sources and/or destinations.

In FIG. 2, the lock controller 106 is configured and arranged to operate with a lock activation and deactivation device 114 to grant or restrict access by the electronic key 102. In one application of the electronic key access control system 100, when a lost/stolen key 102 is harvested, i.e. restricting or denying access by the lost/stolen key 102, the lock controller 106 is updated without having to re-key or replace the lock activation and deactivation device 114.

Also, the electronic key 102 is programmed such that the key 102 is a serialized key for protecting against key copying and includes the memory 112 for storing data such as a key type, a serial number, and access allowance specific to the electronic key 102.

The lock controller 106 may also interface with or communicate to and from a wireless device 116 for various functions, such as an administrative function for sending new command instructions to the lock controller 106 or downloading data from the lock controller 106, etc.

FIG. 3 illustrates another embodiment of a key receptacle 118 of the electronic key access control system 100 in accordance with the principles of the present invention. The key receptacle 118 has a housing longer than the key receptacle 106 shown in FIG. 1. The key receptacle 106 is lighter and smaller than the key receptacle 118, whereas the key receptacle 118 covers, thereby protecting, more area after the electronic key 102 is inserted into the key receptacle 118.

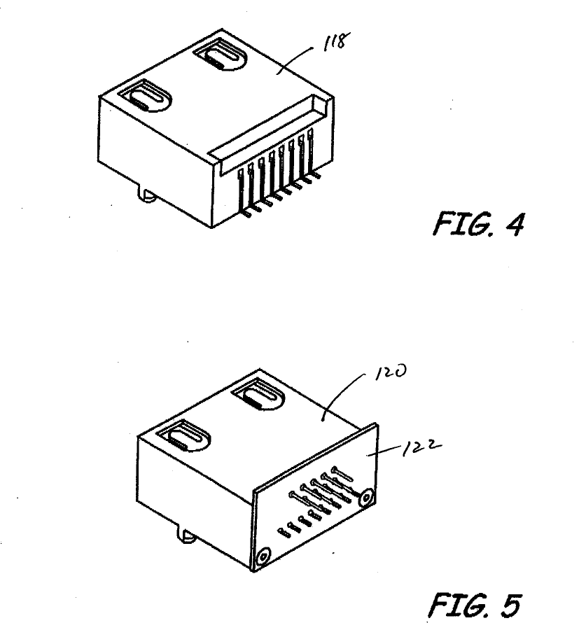

FIG. 4 illustrates a rear perspective view of the second embodiment of the key receptacle 118 shown in FIG. 3 in accordance with the principles of the present invention.

FIG. 5 illustrates a rear perspective view of a third embodiment of a key receptacle 120 of the electronic key system 100 in accordance with the principles of the present invention. A printed circuit board (PCB) 122 can be panel-mounted onto a back end of the key receptacle 118 of FIGS. 3-4. Contact legs or prongs of the key receptacle 120 are soldered onto the printed circuit board 122. The printed circuit board 122 can be attached to a housing unit or device, such as a lock controller. The contact legs or prongs of the key receptacle 118, without the PCB 122, can be directly inserted into a circuit that is placed outside of the electronic key access control system 100.

One of the advantages of the present invention is that the lock controller 106 is a self-contained, scaleable stand-alone unit and does not require computer network. The unit can be easily installed at access points, such as gates, doors, or any other entrances, etc., allowing authorized users to take advantage of the re-programmable memory 112 of the electronic keys 102 for accessing facilities. Instead of using a single, widespread security code, users may carry a rugged, electronic memory key on their key chain to enter or access the facilities. Security is upgraded from “what you know”, such as a numeric pass code, to “what you own”, such as a programmable memory key, and the level of security the users are authorized. Therefore, the system eliminates logistical and cost problems of distributing and changing of access codes. The stand-alone unit allows the control of key programming on a standard PC, thereby significantly reducing expenses when changes in the system need to be made.

Another advantage of the present invention is that the system can instantly grant new users access to doors and gates by programming their keys at an administrator's desk top PC or portable computer, etc. The system allows one to program multiple keys and update the controllers whenever an administrator wishes. Every controller can be set to either admit or restrict users. Accordingly, an administrator is given flexibilities when setting up the system.

A further advantage of the present invention is that the system enhances security by providing users with unique electronic memory keys to access facilities, rather than by distributing a code that easily can be passed onto unauthorized users.

An additional advantage of the present invention is that with the enhanced security by the system, one can reduce expenses incurred through theft or vandalism from unauthorized users.

To implement the electronic key access control system 100, the lock controller 106, which may operate on 12-volt AC/DC power, can be added to each of access control points, such as doors, gates, etc., by replacing or complementing existing mechanical locks or programmable lock sets or magnetic stripe card systems. Each authorized user is given a re-programmable electronic memory key programmed by a facility personnel. Each key contains data that identifies authorized users access to specific facilities, entrances or control points. One exemplary application program can be Datakey Electronics' (the assignee of the present application) GUUARDIAN II software with a reader/writer being connected to a PCs USB or RS-232 port.

To use the system, a user inserts its key into the key receptacle. The lock controller reads and verifies the key's content. If the key is authorized, access is granted. In one embodiment, a tri-color LED and audible buzzer provide visual and audible indications that confirm whether the access by the user is granted or denied.

In one embodiment of the present invention, when the lock controller authorizes access, it activates a timed relay contact that is used to power a door strike or other lock mechanism. After a user entering the door or gate, the strike relocks, and a record of the event is stored in the controllers' memory for reporting purposes. In the event of a power loss, the door strike will either power fail lock or power fail unlock, depending on the type of strike an administrator pre-selects.

The electronic key access control system of the present invention can be configured and arranged for rugged environments and harsh operating conditions, such as dirt, dust, rain, snow, ice, etc. In addition, the system can provide flexibility when creating access privileges for specific groups, date, time, individual users, etc. Also, event transaction data can be exported from each controller to a PC, and reports can be generated in a variety of formats.

Also, the electronic key 102 is a serialized key for protecting against key copying and includes a memory for storing data such as a key type, a unique serial number, and access allowance specific to the electronic key. The serial number cannot be duplicated so as to insure that the data residing on the key cannot be copied for malicious purposes.

The application software can be used to program keys for lock controllers as well as present audit data from user transactions. In one embodiment, the application software has a friendly user interface for ease of use. In one embodiment, a left to right arrangement of buttons and tabbed folders give a user a hierarchical flow for entering pertinent information.

The present invention provides keys for a variety of usage or applications, for example, a user key, an administration key, a data export key, etc. In one embodiment, a user key is defined to be used to access a facility. The user key may have a 1 k-bit memory capacity and can store eight of the most recent audit records, which contain a timestamp and transaction code. An administration or master key is defined to work in all controllers. The master key can transfer controller configuration information, regardless of configuration schedules or lists, from a PC to each controller unit may have a 256 k-bit memory capacity. A data export key is defined to be used to retrieve access transactional data from each controller and transfer it back to the PC where the data can be analyzed and reported on. The data export key may have 256 k-bit capacity. An instant access key is a key that is programmed by an administrator and given out to a user without first having to physically upload configuration information to each controller in the system. The instant access key provides a new user with access to the controlled access point without having to use an administration key to tell the lock controller that the new user is authorized. Accordingly, the system eliminates the need to immediately “administer” the controller every time a new user is added. A harvest key is a key that is disabled by an administrator of the system. After uploading the harvest key list to each controller, if the harvest key is used, the data will be erased from it, thereby rendering it useless. A first key (or referred to as passage key) is a key to allow a user to double-insert its key to set the door into a permanent open mode. When the user double-inserts for the second time, the door is returned to its locked mode. A second feature allows the administrator to choose an auto unlock feature but delay its opening time until a specific key is inserted. The door remains locked until a key of this type is inserted, then goes into the auto unlock mode, for a desired timeframe.

In one embodiment, the lock controller's lock time value can be set from 1-253 seconds, and the event log capacity on the lock controller can be 1,500 events.

The lock controller operates in two modes, restricted mode and admission mode, based on a restriction list and an admission list. An administrator has the option to choose one of the modes when they initialize (or subsequently administer) the controller. This feature is useful for configuring the access point depending on the level of traffic and for minimizing the list needed to be loaded to the controller.

The lock controller may provide for both restrict and admit schedules to be simultaneously implemented within user schedules. Each individual user schedule has a start time, end time, day of week, date, month, year, a recurring flag field, and an access or restrict schedule indicator. A recurring flag can be set to occur once, which uses the date, month, and year information, or Monday to Friday, Monday to Sunday, Saturday and Sunday, or every week which only uses start time, end time, and day of week information, etc. The access or restrict schedule indicator controls whether the current time is within or outside of the schedule.

It is appreciated that the access control system can be used to provide access for as long as a valid user key is inserted and engaged into place. When this feature is combined with schedules, “numbers of accesses” or length of access, it is useful for “vending” access to a location, i.e. providing controlled number and length of access to a location. Also, the system is useful as an access controller to items such as golf carts or machinery—controlling the length of use in lease, rental, or equipment pool accounting applications.

Also, the system has a battery-backed up clock which is set to the correct time-of-day. The user can “adjust” the clock by simply writing the time zone (i.e. Mountain, Pacific, etc.) on an administration key and “administering” the controller. This solves the problem of pre-loading time onto a key, getting to the controller, and waiting for the exact pre-loaded moment to insert the key. Additionally, the same techniques provide for automated handling of Daylight Savings Time (“DST”). DST compensation can be enabled or disabled by users depending upon their local time-of-day conventions.

The system may use both encryption and a unique electronic serial number to prevent the duplication of keys and subversion of the access control system. This feature controls the maximum number of access the user can have to the access points. The controller automatically decrements this value once it has granted access to the user.

The system may also provide for a pulsed output at a given frequency. This output provides access control for machinery which contains the correspondingly programmed controller. The machinery's controller looks for the given frequency and if it appears, the controller “fires up” or turns on the machine. This feature thwarts thieves and vandals because it prevents “hotwiring”.

The system may further provide for field updates of the firmware. Instead of requiring either firmware to be updated by carrying a battery-operated or AC-powered laptop or handheld device that has the new firmware out to the controller and downloading the firmware via a wired or wireless communication port to the controller, or providing a network connection which is costly, the system of the present invention provides administration keys with large data capacity to update firmware simply by inserting an administration key into the system. In another embodiment, the system has a serial interface which provides remote administration via wireless device 116, such as a wireless transceiver or cellular phone, etc.

Further, the system of the present invention has a unique data logging implementation for an audit trail. A user is able to download the sequence of events, via a data export key, since the last download, or download the entire amount of information contained in the memory of the controller. This saves export time and provides for many controllers to export their data onto one single export key, yet provides for security since the log of the events is never erased from the memory of the controller in case that an export key is lost or the export process somehow fails or is interrupted.

In one embodiment of the present invention, multiple controllers can be set up in separate, unique configurations using a single administration key.

The configuration of the key receptacle can be different as shown in FIGS. 1, 3 and 5. FIG. 1 shows a slim board mount key receptacle 104. FIG. 3 shows a board mount key receptacle 118. FIG. 5 shows a slim panel mount key receptacle 120 with the board 122. Also, the key receptacle can b remotely located from the controller. In one embodiment, the key receptacle can be located more than 50 feet from the controller.

It is appreciated that the electronic key access control system may use many other types, shapes, and configurations of electronic keys and key receptacles.

Also, the system provides a “panic key”, which is an administration key that sets the controller into an “always closed” state. This may be used in case of a terrorist or personal safety emergency. The implementation is to set the “re-lock” delay to zero seconds, effectively causing any valid user key to activate the lock for zero seconds (effectively being unable to open the door, etc.). This “always closed” state can be “overcome” by insertion of a master key or a pre-defined method of unlocking operation. An administration key can also overcome this situation by re-setting the “re-lock” delay to its usual value.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. An electronic key access control system, comprising:
an electronic key;
a key receptacle for receiving the electronic key; and
a stand-alone, programmable electronic lock controller, coupled to the key receptacle, being operable in a plurality of access modes to allow access depending on a level of access allowance granted to the electronic key, the electronic lock controller being programmable by the electronic key.

2. The system of claim 1, wherein the controller comprises a memory for storing data related to a plurality of electronic keys and respective levels of access allowance and operation events of the electronic keys.

3. The system of claim 1, wherein the controller is capable of being updated by data transferred from the electronic key and capable of downloading data to the electronic key.

4. The system of claim 1, wherein the controller is configured and arranged to operate with a lock activation and deactivation device to grant or restrict access by the electronic key.

5. The system of claim 1, wherein when the electronic key is lost/stolen, access by the lost/stolen electronic key is restricted by updating the controller without having to re-key or replace the lock activation and deactivation device.

6. The system of claim 1, wherein the electronic key has different key types including a user access key, an administrative key, and a data transfer key.

7. The system of claim 1, wherein the electronic key is a serialized key for protecting against key copying and comprises a memory for storing data such as a key type, a unique serial number, and access allowance specific to the electronic key.
